(19) United States
(12) Patent Application Publication
(10) Pub. No.: US 2009/0132885 A1
(43) Pub. Date: May 21, 2009

(54) SYSTEM AND METHOD FOR RETRANSMITTING DATA IN A COMMUNICATION SYSTEM

(75) Inventors: Young-Jun PARK, Seoul (KR); Min-Young AHN, Seongnam-si (KR); Jin-Bong CHANG, Suwon-si (KR); Kug SHIN, Seoul (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/274,204

(22) Filed: Nov. 19, 2008

(30) Foreign Application Priority Data
Nov. 20, 2007 (KR) 10-2007-0118486

(51) Int. Cl. H04L 1/18; G06F 11/14; H04B 7/02

(52) U.S. Cl. 714/748; 375/267; 714/E11.113

(57) ABSTRACT

A system and method for retransmitting an encoding block in a communication system is provided. The method includes determining the number of encoding blocks to be retransmitted, determining whether a number of encoding blocks to be retransmitted is a multiple of the number of streams available for retransmitting the encoding blocks, when the number of encoding blocks to be retransmitted is not a multiple of the number of streams, determining the minimum number of encoding blocks, additionally needed to meet a condition that the number of encoding blocks to be retransmitted is a multiple of the number of streams, and allocating wireless resources of the streams to the encoding blocks to be retransmitted, retransmitting the encoding blocks to a receiver, and at the same time, allocating wireless resources, which are not allocated to the encoding blocks to be retransmitted, among the wireless resources of the streams, to encoding blocks corresponding to the additionally needed number, and repeatedly retransmitting the encoding blocks to the receiver.

### PRIORITY

This application claims the benefit under 35 U.S.C. §119(a) of a Korean patent application filed in the Korean Intellectual Property Office on Nov. 20, 2007 and assigned Serial No. 10-2007-0118486, the entire disclosure of which is hereby incorporated by reference.

### BACKGROUND OF THE INVENTION

1. Field of the Invention

The present invention relates to a system and method for retransmitting data in a communication system. More particularly, the present invention relates to a system and method for retransmitting data in a Multiple Input Multiple Output (MIMO) communication system.

2. Description of the Related Art

Active research is being conducted on a next-generation communication system, capable of high-speed communications, that processes and transmits a variety of information such as video, wireless data, etc, beyond voice-oriented services, and that increases system efficiency by using a proper encoding scheme for the system.

However, when data is transmitted, an information loss may occur according to the channel condition due to an inevitable error caused by noise, interference, fading, etc. In order to reduce the information loss, various error control schemes, in which channel properties are considered, are used to increase reliability of the system. A conventional error control scheme is a Hybrid Automatic Retransmission reQuest (HARQ) scheme.

With reference to FIG. 1, a description will now be made of an operation of retransmitting data using an HARQ scheme in a conventional Multiple Input Multiple Output (MIMO) communication system. The communication system described below is assumed to be a communication system that transmits data with 4 MIMO streams.

FIG. 1 is a diagram illustrating an operation of retransmitting data using an HARQ scheme in a conventional MIMO communication system.

Referring to FIG. 1, the communication system includes a signal transmitter (e.g. a Base Station (BS)) 100, and a signal receiver (e.g. a Mobile Station (MS)) 110. Although not illustrated, the BS 100 includes a Media Access Control (MAC) scheduler and an HARQ module, and the MS 110 includes a transceiver.

The MAC scheduler of the BS 100 initially transmits a plurality of data frames, e.g., encoding blocks, to the MS 110 through a stream #1 121, a stream #2 131, a stream #3 141 and a stream #4 151 in step 120. It is assumed herein that the encoding blocks are assigned ACKnowledgement (ACK) IDentifiers (IDs) (hereinafter referred to as ‘ACID’) of ACIDs #1 to #16.

Upon receiving the encoding blocks ACID=1 123 to ACID=16 159, the transceiver of the MS 110 feeds back to the BS 100 an ACK message including information on the normally received encoding blocks among the received encoding blocks in step 140. The term ‘ACK message’ as used herein refers to a message generated in such a manner that the transceiver of the MS 110, when it normally receives an encoding block, sets a bit corresponding to the normally received encoding block to ‘1’, and when it abnormally receives an encoding block, sets a bit corresponding to the abnormally received encoding block to ‘0’. Since the transceiver of the MS 110 has abnormally received encoding blocks ACID=1 123, ACID=3 143, ACID=5 125, ACID=7 (145) and ACID=8 (155), and normally received encoding blocks ACID=2 133, ACID=4 153, ACID=6 135, ACID=9 127, ACID=10 137, ACID=11 147, ACID=12 157, ACID=13 129, ACID=14 139, ACID=15 149 and ACID=16 159, an ACK message being fed back to the BS 100 is ‘0101010011111111’.

Meanwhile, a process in which the transceiver of the MS 110 determines whether it has normally received an encoding block, includes a process of determining whether an encoding block has been received from the BS 100, and a process of determining, when the encoding block has been received, whether an error has occurred in the received encoding block. Determining whether an error has occurred in the received encoding block can be made using a Cyclic Redundancy Check (CRC) code.

Upon receiving an ACK message for its transmitted encoding blocks from the transceiver of the MS 110, the MAC scheduler of the BS 100 detects the abnormally received encoding blocks ACID=1 123, ACID=3 143, ACID=5 125, ACID=7 145 and ACID=8 155 according to the received ACK message. The MAC scheduler of the BS 100 retransmits the detected encoding blocks to the MS 110 through a stream #1 161, a stream #2 171, a stream #3 181, and a stream #4 191 in step 160. Therefore, the encoding blocks ACID=1 163 and ACID=8 165 are retransmitted to the MS 110 through the stream #1 161, and the encoding blocks ACID=3 173, ACID=5 183 and ACID=7 193 are retransmitted to the MS 110 through the stream #2 171, stream #3 181 and stream #4 191, respectively.

However, in the conventional MIMO communication system, in the case where a BS retransmits the abnormally received encoding blocks, if the number of the encoding blocks to be retransmitted is not a multiple of the number of MIMO streams used for the retransmission, all wireless resources of the MIMO streams are not used, thereby resulting in a waste of wireless resources. The term ‘all wireless resources’ as used herein means all wireless resources available for transmission of data through the MIMO streams. That is, in FIG. 1, since the number of streams to be used for retransmission of encoding blocks is 4 but the number of encoding blocks to be retransmitted is 5, wireless resources of each of the stream #2 171, the stream #3 181, and the stream #4 191 are half allocated to the encoding blocks, and the remaining half wireless resources are wasted.

### SUMMARY OF THE INVENTION

An aspect of the present invention is to address at least the above-mentioned problems and/or disadvantages and to provide at least the advantages described below. Accordingly, an aspect of the present invention is to provide a system and method capable of retransmitting data without a waste of wireless resources by using an HARQ scheme to which a Chase Combining (CC) scheme is applied in a Multiple Input Multiple Output (MIMO) communication system.

Another aspect of the present invention is to provide a system and method capable of retransmitting data without a waste of wireless resources by using an HARQ scheme to which an Incremental Redundancy (IR) scheme is applied in a MIMO communication system.

In accordance with an aspect of the present invention, a method for retransmitting an encoding block in a communication system is provided. The method includes determining a number of encoding blocks to be retransmitted, determining whether the number of encoding blocks to be retransmitted is a multiple of the number of streams available for retransmitting the encoding blocks, when the number of encoding blocks to be retransmitted is not a multiple of the number of streams, determining the minimum number of encoding blocks, additionally needed to meet a condition that the number of encoding blocks to be retransmitted is a multiple of the number of streams, and allocating wireless resources of the streams to the encoding blocks to be retransmitted, retransmitting the encoding blocks to a receiver, and at the same time, allocating wireless resources, which are not allocated to the encoding blocks to be retransmitted, among the wireless resources of the streams, to encoding blocks corresponding to the additionally needed number, and repeatedly retransmitting the encoding blocks to the receiver.

In accordance with another aspect of the present invention, a method for retransmitting an encoding block in a communication system is provided. The method includes determining a total size of encoding blocks to be retransmitted, determining whether the total size of encoding blocks is equal to a total size of wireless resources of streams available for retransmitting the encoding blocks, when the total size of encoding blocks is not equal to the total size of wireless resources of streams, decreasing a coding rate of a corresponding encoding block in order of a greatest-retransmission count encoding block to a least-retransmission count encoding block, until the total size of encoding blocks is equal to the total size of wireless resources of streams, and when the total size of encoding blocks is equal to the total size of wireless resources of streams, allocating the wireless resources of streams to the coding rate-decreased encoding blocks and the remaining encoding blocks except for the coding rate-decreased encoding blocks among the encoding blocks to be retransmitted, and retransmitting the encoding blocks to the receiver.

In accordance with yet another aspect of the present invention, an apparatus for retransmitting an encoding block in a communication system is provided. The apparatus includes a MAC scheduler for determining the number of encoding blocks to be retransmitted, for determining whether a number of encoding blocks to be retransmitted is a multiple of the number of streams available for retransmitting the encoding blocks, when the number of encoding blocks to be retransmitted is not a multiple of the number of streams, for determining the minimum number of encoding blocks, additionally needed to meet a condition that the number of encoding blocks to be retransmitted is a multiple of the number of streams, for allocating wireless resources of the streams to the encoding blocks to be retransmitted, for retransmitting the encoding blocks to a receiver, and at the same time, for allocating wireless resources, which are not allocated to the encoding blocks to be retransmitted, among the wireless resources of the streams, to encoding blocks corresponding to the additionally needed number, and for repeatedly retransmitting the encoding blocks to the receiver.

In accordance with still another aspect of the present invention, an apparatus for retransmitting an encoding block in a communication system is provided. The apparatus includes a MAC scheduler for determining a total size of encoding blocks to be retransmitted, for determining whether the total size of encoding blocks is equal to a total size of wireless resources of streams available for retransmitting the encoding blocks, when the total size of encoding blocks is not equal to the total size of wireless resources of streams, for decreasing a coding rate of a corresponding encoding block in order of a greatest-retransmission count encoding block to a least-retransmission count encoding block, until the total size of encoding blocks is equal to the total size of wireless resources of streams, and when the total size of encoding blocks is equal to the total size of wireless resources of streams, for allocating the wireless resources of streams to the coding rate-decreased encoding blocks and the remaining encoding blocks except for the coding rate-decreased encoding blocks among the encoding blocks to be retransmitted, and for retransmitting the encoding blocks to a receiver.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description when taken in conjunction with the accompanying drawings, in which:

FIG. 1 is a diagram illustrating an operation of retransmitting data using a Hybrid Automatic Retransmission reQuest (HARQ) scheme in a conventional Multiple Input Multiple Output (MIMO) communication system;

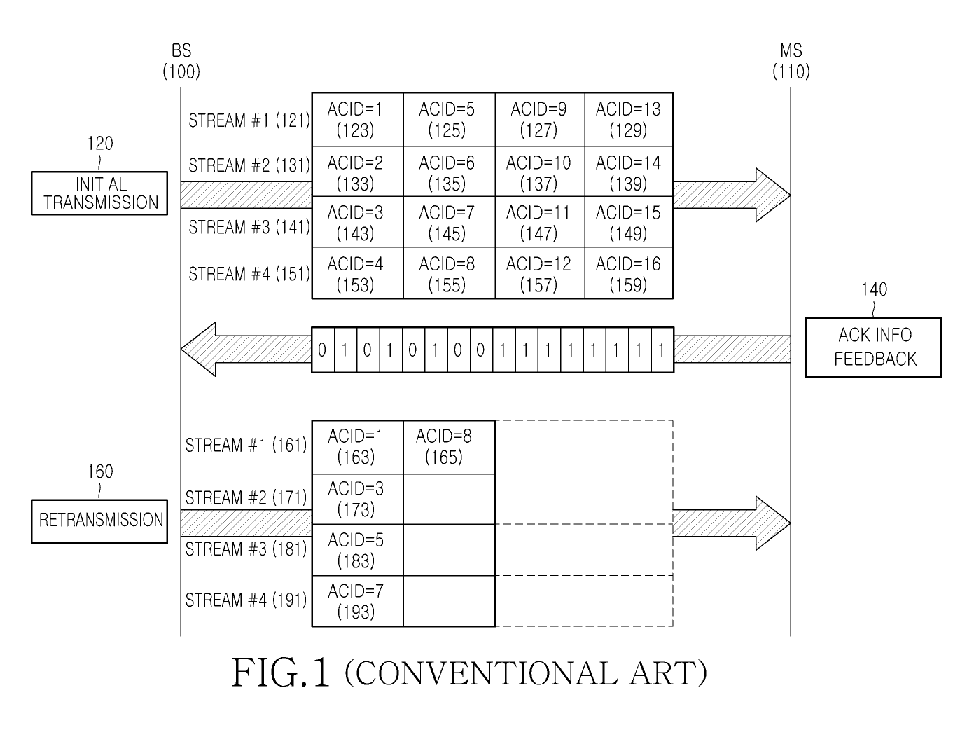

FIG. 2 is a diagram illustrating an operation of retransmitting data using a Chase Combining-HARQ (CC-HARQ) scheme in a MIMO communication system according to a first exemplary embodiment of the present invention;

FIG. 3 is a diagram illustrating an operation of retransmitting data using a CC-HARQ scheme in a MIMO communication system according to a second exemplary embodiment of the present invention;

FIG. 4 is a flowchart illustrating a process of retransmitting data using a CC-HARQ scheme by a Base Station (BS) in a MIMO communication system according to an exemplary embodiment of the present invention;

FIG. 5 is a diagram illustrating an operation of retransmitting data using an Incremental Redundancy-HARQ (IR-HARQ) scheme in a MIMO communication system according to a third exemplary embodiment of the present invention;

FIG. 6 is a diagram illustrating an operation of retransmitting data using an IR-HARQ scheme in a MIMO communication system according to a fourth exemplary embodiment of the present invention; and

FIG. 7 is a flowchart illustrating a process of retransmitting data using an IR-HARQ scheme by a BS in a MIMO communication system according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention provide a system and method capable of retransmitting data without a waste of wireless resources by using a Hybrid Automatic Retransmission reQuest (HARQ) scheme to which a Chase Combining (CC) scheme is applied in a Multiple Input Multiple Output (MIMO) communication system. Further, exemplary embodiments of the present invention provide a system and method capable of retransmitting data without a waste of wireless resources by using an HARQ scheme to which an Incremental Redundancy (IR) scheme is applied in a MIMO communication system.

Before a description of exemplary embodiments of the present invention is given, a description will be made of the HARQ scheme to which the CC scheme is applied (hereinafter referred to as a ‘CC-HARQ scheme’) and the HARQ scheme to which the IR scheme is applied (hereinafter referred to as an ‘IR-HARQ scheme’).

In the CC-HARQ scheme, a transmitter transmits data frames having a same format during an initial transmission and retransmission, and a receiver receives the data frames that the transmitter transmitted during the initial transmission and retransmission, and then performs soft combining on the received data frames, to decode the data frames. A detailed description thereof will be given below.

The transmitter transmits data frames having the same format during an initial transmission and retransmission. Herein, the data frames are data frames which are encoded with an error correction code. That is, in the case where the data frame that the transmitter initially transmitted is not normally received due to an occurrence of an error at the receiver, the transmitter retransmits to the receiver the same data frame as the data frame it transmitted during the initial transmission.

Meanwhile, when the data frame that the transmitter initially transmitted is received, the receiver decodes the received data frame and determines if an error has occurred in the received data frame. Thereafter, if an error has occurred in the received data frame, the receiver buffers the data frame, and transmits, to the transmitter, information indicating that the initially transmitted data frame has been abnormally received, thereby requesting retransmission of the corresponding data frame. Thereafter, the receiver receives a data frame retransmitted from the transmitter, soft-combines it with the previously received initially-transmitted data frame, and then decodes the soft-combined data frame.

In the IR-HARQ scheme, a transmitter transmits data frames having different formats during an initial transmission and retransmission, and a receiver receives the data frames that the transmitter transmitted during the initial transmission and retransmission, and then performs code combining on the received data frames, to decode the data frames. A detailed description thereof will be given below.

The transmitter transmits data frames having different formats during an initial transmission and retransmission. Herein, the data frames are data frames which are encoded with an error correction code. That is, in the case where the data frame that the transmitter initially transmitted is not normally received due to occurrence of an error at the receiver, the transmitter retransmits to the receiver a data frame that is different from the data frame it transmitted during the initial transmission. The data frame initially transmitted from the transmitter is different from the retransmitted data frame in their encoding scheme.

Meanwhile, when the data frame that the transmitter initially transmitted is received, the receiver decodes the received data frame and determines if an error has occurred in the received data frame. Thereafter, if an error has occurred in the received data frame, the receiver buffers the data frame, and transmits, to the transmitter, information indicating that the initially transmitted data frame has been abnormally received, thereby requesting retransmission of the corresponding data frame. Thereafter, the receiver receives a data frame retransmitted from the transmitter, code-combines it with the previously received initially-transmitted data frame, and then decodes the code-combined data frame.

Meanwhile, the receiver includes a reception quality detector measuring quality of received signal through each of MIMO stream, the reception quality detector can periodically or aperiodically transmit, to the transmitter, measured reception quality information for each of a plurality of MIMO streams so that the transmitter can select a MIMO stream it will use when retransmitting the data frame. In this case, the transmitter selects a MIMO stream having the best reception quality based on the received reception quality information, and transmits a data frame through the selected MIMO stream.

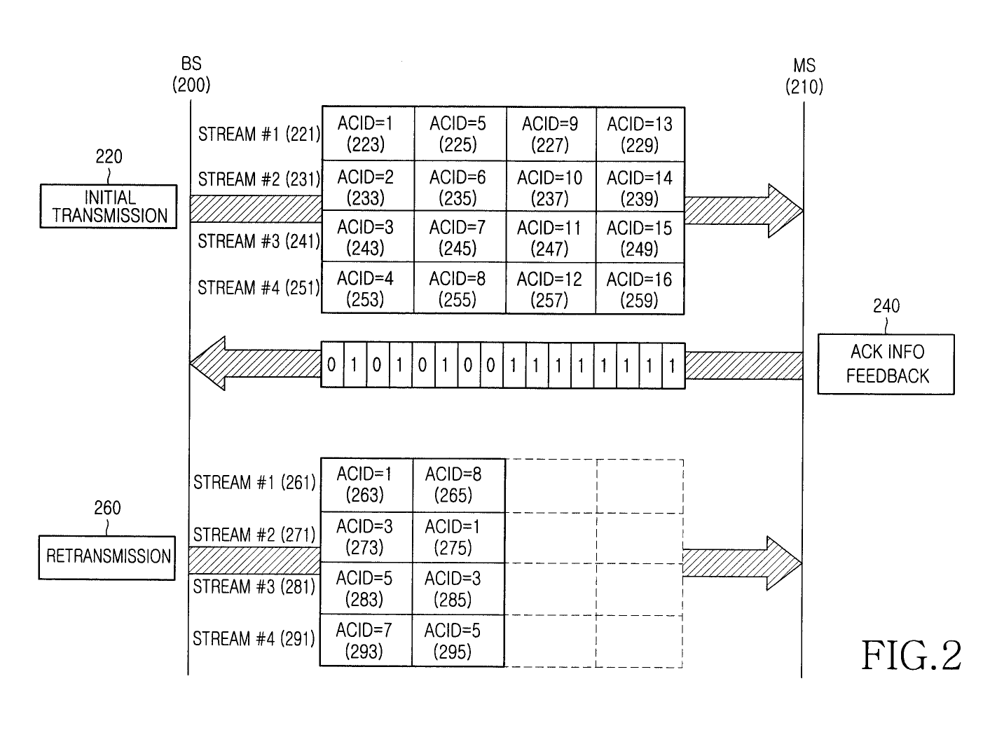

FIG. 2 is a diagram illustrating an operation of retransmitting data using a CC-HARQ scheme in a MIMO communication system according to a first exemplary embodiment of the present invention.

Referring to FIG. 2, the communication system includes a signal transmitter (e.g. a Base Station (BS)) 200, and a signal receiver (e.g. a Mobile Station (MS)) 210. Although not illustrated, the BS 200 includes a Media Access Control (MAC) scheduler and an HARQ module, and the MS 210 includes a transceiver.

The MAC scheduler of the BS 200 initially transmits a plurality of data frames, e.g., encoding blocks, to the MS 210 through a stream #1 221, a stream #2 231, a stream #3 241, and a stream #4 251 in step 220. It is assumed herein that the encoding blocks are assigned ACKnowledgement (ACK) IDentifiers (IDs) (hereinafter referred to as ‘ACIDs’) #1 to #16. Further, the encoding blocks are transmitted using the same Modulation and Coding Scheme (MCS) level.

Upon receiving the encoding blocks ACID=1 223 to ACID=16 259, the transceiver of the MS 210 feeds back to the BS 200 an ACK message including information on the normally received encoding blocks among the received encoding blocks in step 240. The term ‘ACK message’ as used herein refers to a message generated in such a manner that the transceiver of the MS 210, when it normally receives an encoding block, sets a bit corresponding to the normally received encoding block to ‘1’, and when it abnormally receives an encoding block, sets a bit corresponding to the abnormally received encoding block to ‘0’. Since the transceiver of the MS 210 has abnormally received encoding blocks ACID=1 223, ACID=3 243, ACID=5 225, ACID=7 245 and ACID=8 255, and normally received encoding blocks ACID=2 233, ACID=4 253, ACID=6 235, ACID=9 227, ACID=10 237, ACID=11 247, ACID=12 257, ACID=13 229, ACID=14 239, ACID=15 249 and ACID=16 259, an ACK message being fed back to the BS 200 is ‘0101010011111111’.

Meanwhile, a process in which the transceiver of the MS 210 determines whether it has normally received an encoding block, includes a process of determining whether an encoding block has been received from the BS 200, and a process of determining, when the encoding block has been received, whether an error has occurred in the received encoding block. Determining whether an error has occurred in the received encoding block can be made using a Cyclic Redundancy Check (CRC) code.

Upon receiving an ACK message for its transmitted encoding blocks from the transceiver of the MS 210, the MAC scheduler of the BS 200 detects the abnormally received encoding blocks ACID=1 223, ACID=3 243, ACID=5 225, ACID=7 245 and ACID=8 255 indicated by the received ACK message, and retransmits the detected encoding blocks to the MS 210 through a stream #1 261, a stream #2 271, a stream #3 281, and a stream #4 291 in step 260. Since the number of the abnormally received encoding blocks that the MAC scheduler of the BS 200 has detected is 5 and the number of MIMO streams through which the BS 200 will retransmit the detected encoding blocks is 4, wireless resources of the stream #2 271, the stream #3 281, and the stream #4 291 are partially allocated to the encoding blocks.

Therefore, the MAC scheduler of the BS 200 reallocates wireless resources to which no encoding block is allocated, among the wireless resources of the stream #2 271, the stream #3 281, and the stream #4 291, to the encoding blocks having a greater retransmission count (or the number of retransmissions), and repeatedly retransmits the encoding blocks. The encoding blocks having a greater retransmission count are detected by the HARQ module of the BS 200, and the HARQ module of the BS 200 manages the retransmission count for the encoding blocks. When the MS 210 normally receives an encoding block initially transmitted from the BS 200, the retransmission count is 0, but when the MS 210 abnormally receives an encoding block initially transmitted from the BS 200, the retransmission count is 1. That is the retransmission count increases by 1 every time the MS 210 abnormally receives an encoding block transmitted from the BS 200. It is assumed in FIG. 2 that encoding blocks ACID=1 223, ACID=3 243 and ACID=5 225 that the HARQ module of the BS 200 detected through the above process, have a greater retransmission count. It is assumed that in terms of a value of the retransmission count, ACID=1 223>ACID=3 243>ACID=5 225, meaning that the retransmission count of the encoding block ACID=1 223 is the greatest and the retransmission count of the encoding block ACID=5 225 is the least.

Meanwhile, in the case where after initially transmitting encoding blocks to the MS 210, the BS 200 performs retransmission on the abnormally received encoding blocks among the initially transmitted encoding blocks, if retransmission counts of the encoding blocks are all 0, the BS 200 performs retransmission according to the order in which the encoding blocks were previously transmitted, i.e., according to the order in which the BS 200 initially transmitted the encoding blocks to the MS 210.

That is, the BS 200 allocates wireless resources of the stream #1 261, the stream #2 271, the stream #3 281, and the stream #4 291 to the encoding blocks ACID=1 263, ACID=3 273, ACID=5 283, ACID=7 293 and ACID=8 265, retransmits them to the MS 210, reallocates the wireless resources to which no encoding block is allocated, among the wireless resources of the streams, to the encoding blocks ACID=1 275, ACID=3 285 and ACID=5 295, and repeatedly retransmits the encoding blocks ACID=1 275, ACID=3 285 and ACID=5 295. Therefore, the BS 200 can use all the wireless resources of the MIMO streams without waste, and for the repeatedly retransmitted encoding blocks ACID=1 263,275, ACID=3 273,285 and ACID=5 283,295, it is also possible to increase the reception gain due to the repetition.

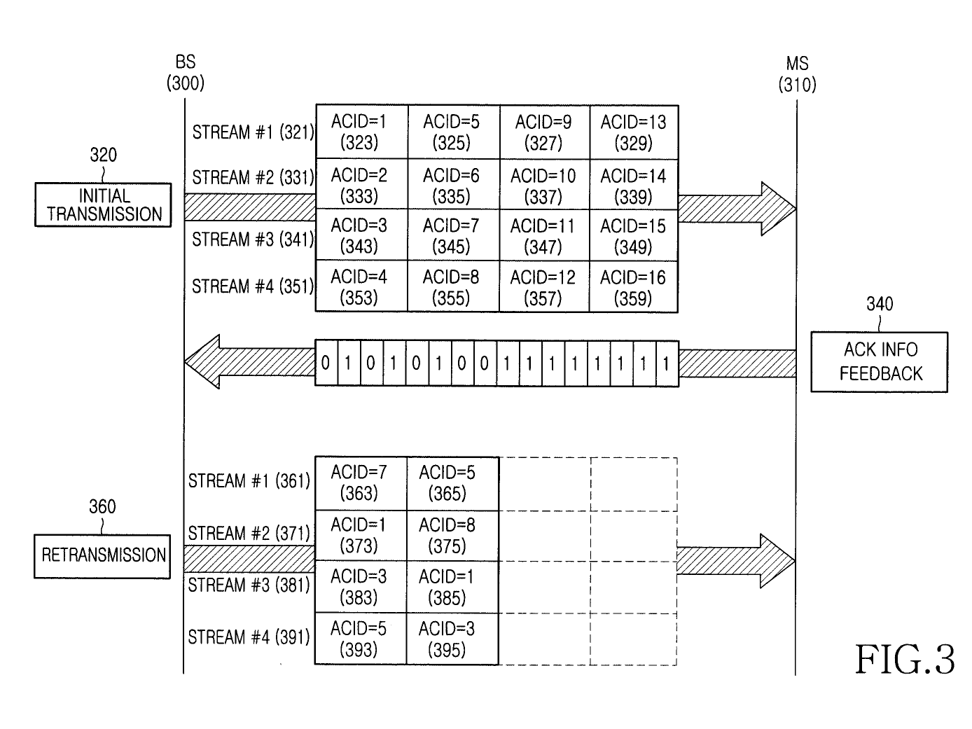

With reference to FIG. 2, a description has been made as to exemplary data retransmission for the case where the MS does not transmit reception quality information for MIMO streams to the BS. Next, with reference to FIG. 3, a description will be made of data retransmission for the case where the MS transmits reception quality information for MIMO streams to the BS.

FIG. 3 is a diagram illustrating an operation of retransmitting data using a CC-HARQ scheme in a MIMO communication system according to a second exemplary embodiment of the present invention.

Referring to FIG. 3, the communication system includes a signal transmitter (e.g. a BS) 300, and a signal receiver (e.g. an MS) 310. Although not illustrated, the BS 300 includes a MAC scheduler and an HARQ module, and the MS 310 includes a transceiver and a reception quality detector.

The MAC scheduler of the BS 300 initially transmits encoding blocks to the MS 310 through a stream #1 321, stream #2 331, stream #3 341 and stream #4 351 in step 320. The initially transmitted encoding blocks includes ACID=1 323, ACID=2 333, ACID=3 343, ACID=4 353, ACID=5 325, ACID=6 335, ACID=7 345, ACID=8 355, ACID=9 327, ACID=10 337, ACID=11 347, ACID=12 357, ACID=13 329, ACID=14 339, ACID=15 349 and ACID=16 359. Since a process in step 340 in which the transceiver of the MS 310 feeds back an ACK message to the BS 300 is similar to steps 220,240 of FIG. 2, a detailed description thereof will be omitted herein.

Meanwhile, the reception quality detector of the MS 310 measures reception quality each of streams #1 321 and 361, streams #2 331 and 371, streams #3 341 and 381 and streams #4 351 and 391and transmits measured reception quality to the BS 300, and it is assumed herein that in terms of the measured reception quality, stream #2 331 and 371 >streams #3 341 and 381 >streams #4 351 and 391 >streams #1 321 and 361, meaning that the reception quality of the streams #2 331 and 371 are highest and the reception quality of the streams #1 321 and 361 are lowest. It is also assumed that in terms of a value of the retransmission count for the encoding blocks, ACID=1>ACID=3>ACID=5>ACID=7>ACID=8, meaning that the retransmission count of the encoding block ACID=1 is greatest and the retransmission count of the encoding block ACID=8 is least.

Upon receiving the ACK message for its transmitted encoding blocks, the MAC scheduler of the BS 300 detects the abnormally received encoding blocks ACID=1 323, ACID=3 343, ACID=5 325, ACID=7 345, ACID=8 355 indicated by the ACK message. Thereafter, in step 360, the MAC scheduler of the BS 300 allocates, in order, wireless resources of the stream #2 371, the stream #3 381, the stream #4 391 and stream #1 361 to the encoding blocks ACID=1 373, ACID=3 383, ACID=5 393 and ACID=7 363, respectively, allocates wireless resources of the stream #2 371 to the encoding block ACID=8 375, and retransmits them to the MS 310. Since the wireless resources of the stream #1 361, the stream #3 381 and the stream #4 391 are partially allocated to the encoding blocks, the MAC scheduler of the BS 300 allocates, in order, wireless resources of the stream #3 381, the stream #4 391 and the stream #1 361 to the encoding blocks ACID=1 385, ACID=3 395 and ACID=5 365 having a greater retransmission count, respectively, and repeatedly retransmits them.

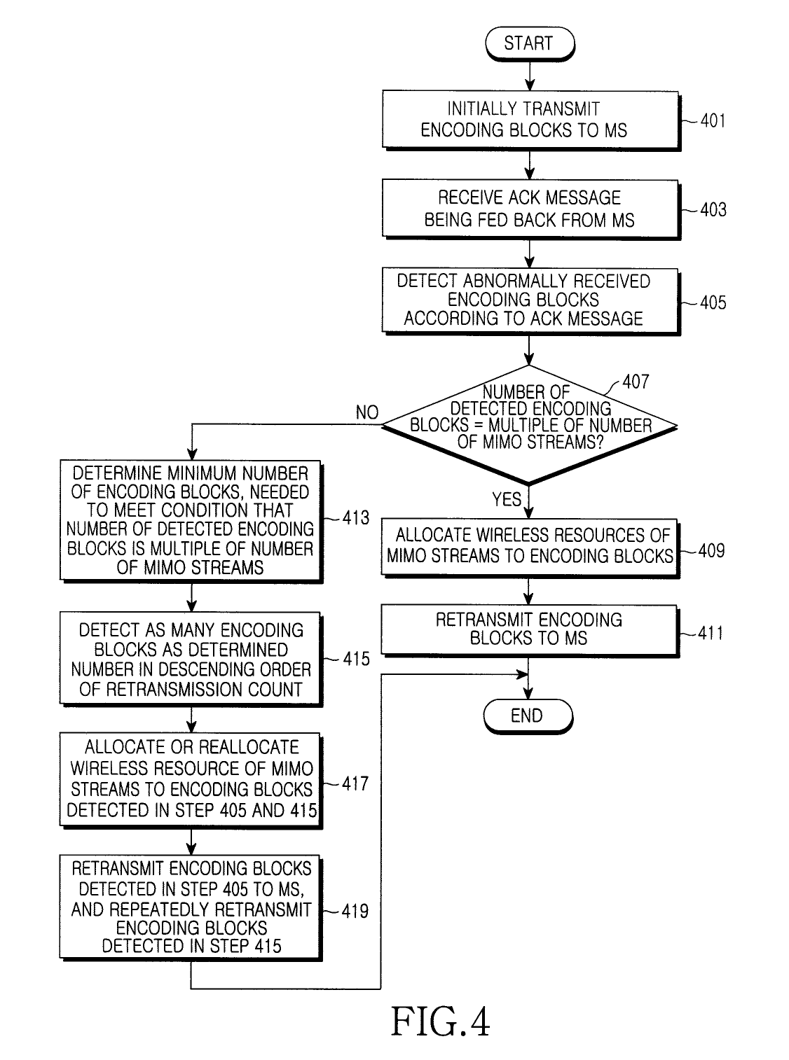

FIG. 4 is a flowchart illustrating a process of retransmitting data using a CC-HARQ scheme by a BS in a MIMO communication system according to an exemplary embodiment of the present invention.

Referring to FIG. 4, in step 401, the BS initially transmits at least two encoding blocks to an MS. In step 403, the BS receives an ACK message being fed back from the MS. In step 405, the BS detects the abnormally received encoding blocks according to the received ACK message. In step 407, the BS determines if the number of the detected encoding blocks is a multiple of the number of MIMO streams. If it is determined that the number of the detected encoding blocks is a multiple of the number of MIMO streams, the BS proceeds to step 409 where it allocates wireless resources of MIMO streams to the detected encoding blocks. In step 411, the BS retransmits the encoding blocks to the MS through the MIMO streams.

However, if it is determined in step 407 that the number of the detected encoding blocks is not a multiple of the number of MIMO streams, the BS proceeds to step 413 where it determines the minimum number of encoding blocks, needed to meet a condition that the number of the detected encoding blocks is a multiple of the number of MIMO streams. In step 415, the BS detects as many encoding blocks as the determined number in descending order of the retransmission count, i.e., in order of a greatest-retransmission count encoding block (an encoding block having a greatest retransmission count) to a least-retransmission count encoding block. In step 417, the BS allocates wireless resources of the MIMO streams to the encoding blocks detected in step 405, and reallocates the wireless resources to which no encoding block is allocated, among the wireless resources of the MIMO streams, to the encoding blocks detected in step 415. In step 419, the BS retransmits the encoding blocks detected in step 405 to the MS through the MIMO streams, and at the same time, repeatedly retransmits the encoding blocks detected in step 415. With reference to FIG. 4, a description has been made as to an example in which the BS uses randomly selected MIMO streams during retransmission and repeated retransmission since it has no information on reception quality of the MIMO streams. However, when the BS receives reception quality information for the MIMO streams from the MS, it can use MIMO streams selected considering the reception quality information, during its retransmission and repeated retransmission.

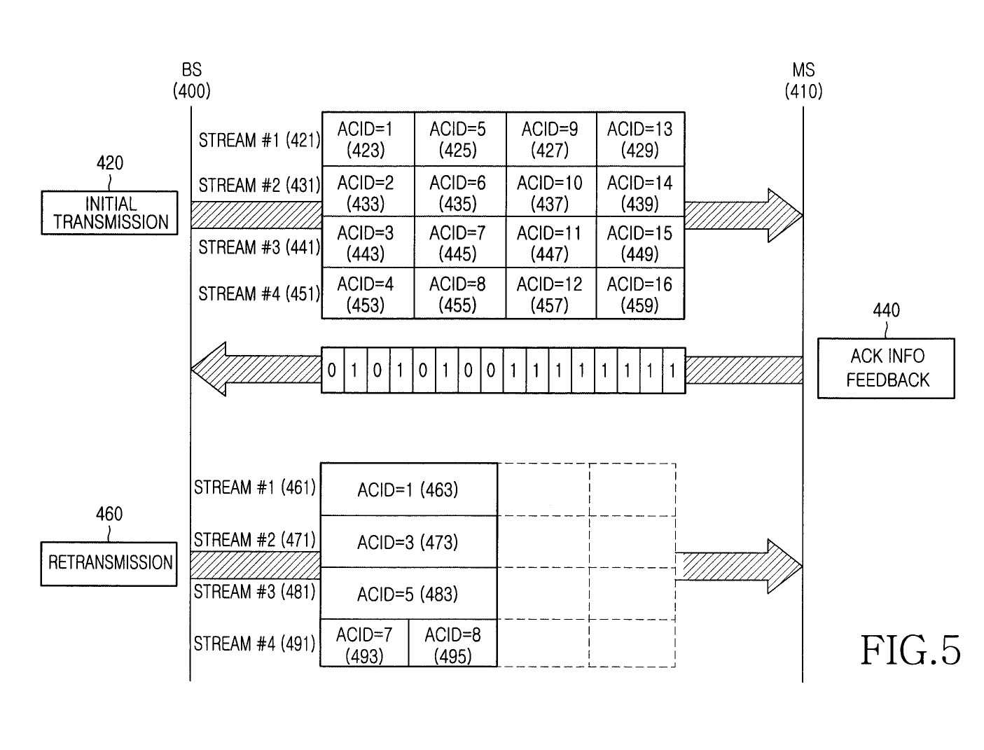

FIG. 5 is a diagram illustrating an operation of retransmitting data using an IR-HARQ scheme in a MIMO communication system according to a third exemplary embodiment of the present invention.

Referring to FIG. 5, the communication system includes a signal transmitter (e.g. a BS) 400, and a signal receiver (e.g. an MS) 410. Although not illustrated, the BS 400 includes a MAC scheduler and an HARQ module, and the MS 410 includes a transceiver.

The MAC scheduler of the BS 400 initially transmits a plurality of data frames, e.g., encoding blocks, to the MS 410 through a stream #1 421, a stream #2 431, a stream #3 441 and a stream #4 451 in step 420. It is assumed herein that the encoding blocks are assigned ACIDs #1 to #16. The initially transmitted encoding blocks includes ACID=1 423, ACID=2 433, ACID=3 443, ACID=4 453, ACID=5 425, ACID=6 435, ACID=7 445, ACID=8 455, ACID=9 427, ACID=10 437, ACID=11 447, ACID=12 457, ACID=13 429, ACID=14 439, ACID=15 449 and ACID=16 459.

Upon receiving the encoding blocks ACID=1 423 to ACID=16 459, the transceiver of the MS 410 feeds back to the BS 400 an ACK message including information on the normally received encoding blocks among the received encoding blocks in step 440. Since the transceiver of the MS 410 has abnormally received encoding blocks ACID=1 423, ACID=3 443, ACID=5 425, ACID=7 445 and ACID=8 455, an ACK message being fed back to the BS 400 is ‘0101010011111111’.

Upon receiving the ACK message for its transmitted encoding blocks, the MAC scheduler of the BS 400 detects the abnormally received encoding blocks ACID=1 423, ACID=3 443, ACID=5 425, ACID=7 445 and ACID=8 455 indicated by the received ACK message, and retransmits the detected encoding blocks to the MS 410 through a stream #1 461, a stream #2 471, a stream #3 481 and a stream #4 491 in step 460.

At this point, since the total size of the abnormally received encoding blocks that the MAC scheduler of the BS 400 detected is not equal to the total size (amount) of the wireless resources of the MIMO streams, the HARQ module of the BS 400 detects the greatest-retransmission count encoding block among the abnormally received encoding blocks, and decreases detected encoding block's coding rate. It is assumed in FIG. 4 that the greatest-retransmission count encoding blocks that the HARQ module of the BS 400 detected are ACID=1 423, ACID=3 443 and ACID=5 425. It is also assumed that in terms of a value of retransmission count, ACID=1 423>ACID=3 443>ACID=5 425, meaning that the retransmission count of the encoding block ACID=1 423 is greatest and the retransmission count of the encoding block ACID=5 425 is least. Thereafter, the HARQ module of the BS 400 determines if the total size of the encoding blocks is equal to the total size of wireless resources of the MIMO streams. If the total size of the encoding blocks is equal to the total size of the wireless resources of the MIMO streams, the HARQ module of the BS 400 retransmits the encoding blocks to the MS 410 through the MIMO streams.

However, if the total size of the encoding blocks is not equal to the total size of the wireless resources of the MIMO streams, the HARQ module of the BS 400 decreases a coding rate of corresponding encoding blocks in order of the greatest-retransmission count encoding block to the least-retransmission count encoding block, until the total size of the encoding blocks is equal to the total size of the wireless resources of the MIMO streams. That is, the HARQ module of the BS 400 decreases a coding rate of the encoding blocks ACID=1 423, ACID=3 443 and ACID=5 425, and then retransmits the coding rate-decreased encoding blocks ACID=1 463, ACID=3 473, ACID=5 483 and encoding blocks ACID=7 493, ACID=8 495 to the MS 410 through the stream #1 461, the stream #2 471, the stream #3 481 and the stream #4 491. Therefore, the HARQ module of the BS 400 can use all the wireless resources of the MIMO streams without waste, and for the coding rate-decreased encoding blocks ACID=1 423, ACID=3 443 and ACID=5 425, it is also possible to increase the reception gain by decreasing coding rate.

The wireless resources of streams for transmitting encoding blocks have the same size during initial transmission 420 and retransmission 460 as described in FIG. 2. Therefore, the wireless resources left after allocating them to the encoding blocks ACID=1 423, ACID=3 443, ACID=5 425, ACID=7 445 and ACID=8 455, can be allocated for transmission other data.

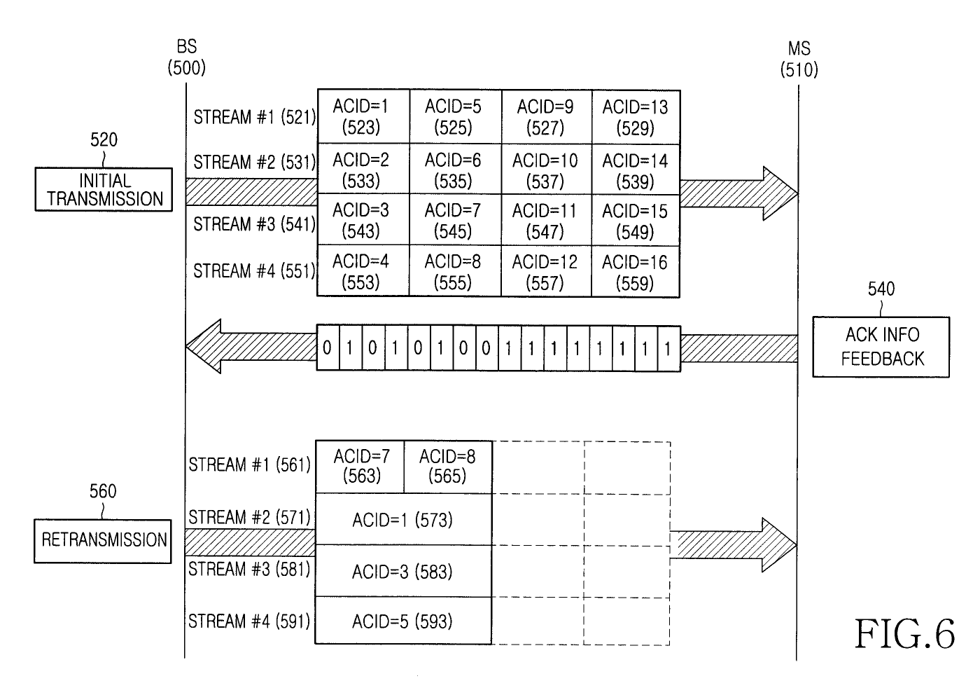

With reference to FIG. 5, a description has been made as to exemplary data retransmission for the case where the MS does not transmit reception quality information for MIMO streams to the BS. Next, with reference to FIG. 6, a description will be made of data retransmission for the case where the MS transmits reception quality information for MIMO streams to the BS.

FIG. 6 is a diagram illustrating an operation of retransmitting data using an IR-HARQ scheme in a MIMO communication system according to a fourth exemplary embodiment of the present invention.

Referring to FIG. 6, the communication system includes a signal transmitter (e.g. a BS) 500, and a signal receiver (e.g. an MS) 510. Although not illustrated, the BS 500 includes a MAC scheduler and an HARQ module, and the MS 510 includes a transceiver and a reception quality detector.

The MAC scheduler of the BS 500 initially transmits encoding blocks to the MS 510 through a stream #1 521, a stream #2 531, stream #3 541, stream #4 551 in step 520. The initially transmitted encoding blocks includes ACID=1 523, ACID=2 533, ACID=3 543, ACID=4 553, ACID=5 525, ACID=6 535, ACID=7 545, ACID=8 555, ACID=9 527, ACID=10 537, ACID=11 547, ACID=12 557, ACID=13 529, ACID=14 539, ACID=15 549 and ACID=16 559. Since a process in step 540 in which the transceiver of the MS 510 feeds back an ACK message to the BS 500 is similarly to steps 420,440 of FIG. 5, a detailed description thereof will be omitted herein.

Meanwhile, the reception quality detector of the MS 510 measures reception quality each of streams #1 521 and 561, streams #2 531 and 571, streams #3 541 and 581 and streams #4 551 and 591 and transmits measured reception quality to the BS 500, and it is assumed herein that in terms of the measured reception quality, streams #2 531 and 571>streams #3 541 and 581>streams #4 551 and 591>streams #1 521 and 561, meaning that the reception quality of the streams #2 531 and 571 is highest and the reception quality of the streams #1 521 and 561 are lowest. It is also assumed that in terms of a value of the retransmission count for the encoding blocks, ACID=1>ACID=3>ACID=5>ACID=7>ACID=8, meaning that the retransmission count of the encoding block ACID=1 is greatest and the retransmission count of the encoding block ACID=8 is the least.

Upon receiving an ACK message for its transmitted encoding blocks, the MAC scheduler of the BS 500 detects the abnormally received encoding blocks ACID=1 523, ACID=3 543, ACID=5 525, ACID=7 545 and ACID=8 555 indicated by the received ACK message, and retransmits the detected encoding blocks to the MS 510 through the stream #1 561, the stream #2 571, the stream #3 581 and the stream #4 591 in step 560. At this point, since the total size of the detected encoding blocks is not equal to the total size of the wireless resources of the MIMO streams, the HARQ module of the BS 500 decreases a coding rate of corresponding encoding blocks in order of the greatest-retransmission count encoding block to the least-retransmission count encoding block, until the total size of the encoding blocks is equal to the total size of the wireless resources of the MIMO streams. That is, the HARQ module of the BS 500 decreases a coding rate of the encoding blocks ACID=1 523, ACID=3 543 and ACID=5 525, and then retransmits the coding rate-decreased encoding blocks ACID=1 573, ACID=3 583 and ACID=5 593 to the MS 510 through the highest-reception quality stream #2 571, stream #3 581 and stream #4 591, and retransmits the encoding blocks ACID=7 563 and ACID=8 565 to the MS 510 through the lowest-reception quality stream #1 561.

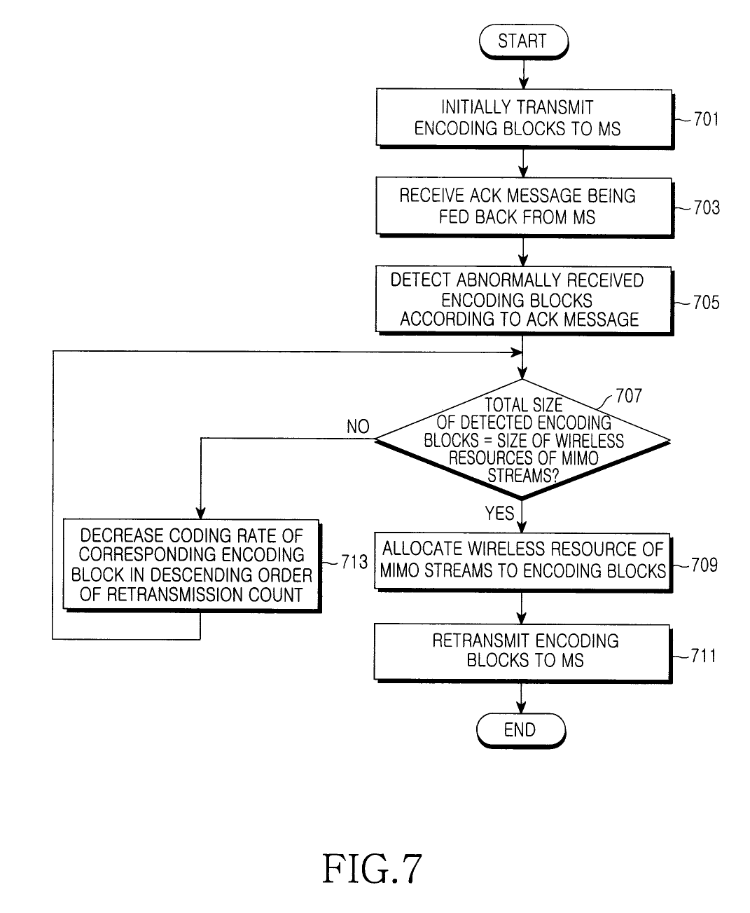

FIG. 7 is a flowchart illustrating a process of retransmitting data using an IR-HARQ scheme by a BS in a MIMO communication system according to an exemplary embodiment of the present invention.

Referring to FIG. 7, in step 701, the BS initially transmits at least two encoding blocks to an MS. In step 703, the BS receives an ACK message being fed back from the MS. In step 705, the BS detects the abnormally received encoding blocks according to the received ACK message. In step 707, the BS determines if the total size of the detected encoding blocks is equal to a size of the wireless resources of MIMO streams. If it is determined that the total size of the detected encoding blocks is equal to a size of the wireless resources of the MIMO streams, the BS proceeds to step 709 where it allocates wireless resources of the MIMO streams to the detected encoding blocks. In step 711, the BS retransmits the encoding blocks to the MS through the MIMO streams.

However, if it is determined in step 707 that the total size of the detected encoding blocks is not equal to the size of the wireless resources of the MIMO streams, the BS proceeds to step 713 where it detects corresponding encoding blocks in order of the greatest-retransmission count encoding block to the least-retransmission count encoding block, decreases a coding rate thereof, and then returns to step 707.

As is apparent from the foregoing description, according to exemplary embodiments of the present invention, the MIMO communication system can retransmit data without a waste of wireless resources by using the CC-HARQ scheme and the IR-HARQ scheme, thereby increasing efficiency of the wireless resources and thus acquiring system gain.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for retransmitting an encoding block in a communication system, the method comprising:
determining a number of encoding blocks to be retransmitted;
determining whether the number of encoding blocks to be retransmitted is a multiple of the number of streams available for retransmitting the encoding blocks;
when the number of encoding blocks to be retransmitted is not a multiple of the number of streams, determining the minimum number of encoding blocks, additionally needed to meet a condition that the number of encoding blocks to be retransmitted is a multiple of the number of streams; and
allocating wireless resources of the streams to the encoding blocks to be retransmitted, retransmitting the encoding blocks to a receiver, and at the same time, allocating wireless resources, which are not allocated to the encoding blocks to be retransmitted, among the wireless resources of the streams, to encoding blocks corresponding to the additionally needed number, and repeatedly retransmitting the encoding blocks to the receiver.

2. The method of claim 1, further comprising:
when the number of encoding blocks to be retransmitted is a multiple of the number of streams, allocating wireless resources of the streams to the encoding blocks to be retransmitted, and retransmitting the encoding blocks to the receiver.

3. The method of claim 1, wherein the encoding blocks corresponding to the additionally needed number are determined in order of a greatest-retransmission count encoding block to a least-retransmission count encoding block.

4. The method of claim 1, further comprising:
receiving reception quality information for each of the streams from the receiver; and
allocating wireless resources of corresponding streams to the encoding blocks to be retransmitted and the encoding blocks corresponding to the additionally needed number, in order of a highest-reception quality stream to a lowest-reception quality stream.

5. The method of claim 1, wherein the encoding blocks to be retransmitted are encoding blocks which are transmitted using a same Modulation and Coding Scheme (MCS) level.

6. A method for retransmitting an encoding block in a communication system, the method comprising:
determining a total size of encoding blocks to be retransmitted;
determining whether the total size of encoding blocks is equal to a total size of wireless resources of streams available for retransmitting the encoding blocks;
when the total size of encoding blocks is not equal to the total size of wireless resources of streams, decreasing a coding rate of a corresponding encoding block in order of a greatest-retransmission count encoding block to a least-retransmission count encoding block, until the total size of encoding blocks is equal to the total size of wireless resources of streams; and
when the total size of encoding blocks is equal to the total size of wireless resources of streams, allocating the wireless resources of streams to the coding rate-decreased encoding blocks and the remaining encoding blocks except for the coding rate-decreased encoding blocks among the encoding blocks to be retransmitted, and retransmitting the encoding blocks to the receiver.

7. The method of claim 6, further comprising:
receiving reception quality information for each of the streams from the receiver; and
allocating wireless resources of corresponding rate-decreased encoding blocks and the remaining encoding blocks except for the streams to the cod coding rate-decreased encoding blocks among the encoding blocks to be retransmitted, in order of a highest-reception quality stream to a lowest-reception quality stream.

8. A method for receiving an encoding blocks in a communication system, the method comprising:
measuring reception quality of each of streams, which is used to receive the encoding blocks, and transmitting the measured reception quality to a transmitter;
receiving the encoding blocks through wireless resources of corresponding streams from the transmitter, the wireless resources of the corresponding streams being allocated to the encoding blocks in order of a highest-reception quality stream to a lowest-reception quality stream.

9. The method of claim 8, wherein when the number of encoding blocks is not a multiple of the number of streams, wireless resources, which are not allocated to the encoding blocks, among the wireless resources of the streams, are allocated to encoding blocks corresponding to a minimum number of the encoding blocks additionally needed, the minimum number of the encoding blocks additionally needed being determined to meet a condition that the number of encoding blocks is a multiple of the number of streams.

10. The method of claim 8, when a total size of encoding blocks is not equal to a total size of wireless resources of streams, a coding rate of a corresponding encoding block is decreased in order of a greatest-retransmission count encoding block to a least-retransmission count encoding block, until the total size is equal to the total size of wireless resources of streams, and when the total size is equal to the total size of wireless resources of streams, the wireless resources of streams are allocated to the coding rate-decreased encoding blocks and the remaining encoding blocks except for the coding rate-decreased encoding blocks.

11. An apparatus for retransmitting an encoding block in a communication system, the apparatus comprising:
a Media Access Control (MAC) scheduler for determining a number of encoding blocks to be retransmitted, for determining whether the number of encoding blocks to be retransmitted is a multiple of the number of streams available for retransmitting the encoding blocks, when the number of encoding blocks to be retransmitted is not a multiple of the number of streams, for determining the minimum number of encoding blocks, additionally needed to meet a condition that the number of encoding blocks to be retransmitted is a multiple of the number of streams, for allocating wireless resources of the streams to the encoding blocks to be retransmitted, for retransmitting the encoding blocks to a receiver, and at the same time, for allocating wireless resources, which are not allocated to the encoding blocks to be retransmitted, among the wireless resources of the streams, to encoding blocks corresponding to the additionally needed number, and for repeatedly retransmitting the encoding blocks to the receiver.

12. The apparatus of claim 11, wherein when the number of encoding blocks to be retransmitted is a multiple of the number of streams, the MAC scheduler allocates wireless resources of the streams to the encoding blocks to be retransmitted, and retransmits the encoding blocks to the receiver.

13. The apparatus of claim 11, wherein the encoding blocks corresponding to the additionally needed number are determined in order of a greatest-retransmission count encoding block to a least-retransmission count encoding block.

14. The apparatus of claim 11, wherein the MAC scheduler receives reception quality information for each of the streams from the receiver, and allocates wireless resources of corresponding streams to the encoding blocks to be retransmitted and the encoding blocks corresponding to the additionally needed number, in order of a highest-reception quality stream to a lowest-reception quality stream.

15. The apparatus of claim 11, wherein the encoding blocks to be retransmitted are encoding blocks which are transmitted using a same Modulation and Coding Scheme (MCS) level.

16. An apparatus for retransmitting an encoding block in a communication system, the apparatus comprising:
a Media Access Control (MAC) scheduler for determining a total size of encoding blocks to be retransmitted, for determining whether the total size of encoding blocks is equal to a total size of wireless resources of streams available for retransmitting the encoding blocks, when the total size of encoding blocks is not equal to the total size of wireless resources of streams, for decreasing a coding rate of a corresponding encoding block in order of a greatest-retransmission count encoding block to a least-retransmission count encoding block, until the total size of encoding blocks is equal to the total size of wireless resources of streams, and when the total size of encoding blocks is equal to the total size of wireless resources of streams, for allocating the wireless resources of streams to the coding rate-decreased encoding blocks and the remaining encoding blocks except for the coding rate-decreased encoding blocks among the encoding blocks to be retransmitted, and for retransmitting the encoding blocks to a receiver.

17. The apparatus of claim 16, wherein the MAC scheduler receives reception quality information for each of the streams from the receiver, and allocates wireless resources of corresponding streams to the coding rate-decreased encoding blocks and the remaining encoding blocks except for the coding rate-decreased encoding blocks among the encoding blocks to be retransmitted, in order of a highest-reception quality stream to a lowest-reception quality stream.

18. An apparatus for receiving an encoding blocks in a communication system, the apparatus comprising:
a reception detector for measuring reception quality of each of streams, which is used to receive the encoding blocks, and transmitting the measured reception quality to a transmitter;
a transceiver for receiving the encoding blocks through wireless resources of corresponding streams from the transmitter, the wireless resources of the corresponding streams being allocated to the encoding blocks in order of a highest-reception quality stream to a lowest-reception quality stream.

19. The apparatus of claim 18, wherein when the number of encoding blocks is not a multiple of the number of streams, wireless resources, which are not allocated to the encoding blocks, among the wireless resources of the streams, are allocated to encoding blocks corresponding to a minimum number of the encoding blocks additionally needed, the minimum number of the encoding blocks additionally needed being determined to meet a condition that the number of encoding blocks is a multiple of the number of streams.

20. The apparatus of claim 18, when a total size of encoding blocks is not equal to a total size of wireless resources of streams, a coding rate of a corresponding encoding block is decreased in order of a greatest-retransmission count encoding block to a least-retransmission count encoding block, until the total size is equal to the total size of wireless resources of streams, and when the total size is equal to the total size of wireless resources of streams, the wireless resources of streams are allocated to the coding rate-decreased encoding blocks and the remaining encoding blocks except for the coding rate-decreased encoding blocks.
